(19) United States
(12) Patent Application Publication
(10) Pub. No.: US 2011/0145179 A1
(43) Pub. Date: Jun. 16, 2011

(54) FRAMEWORK FOR THE ORGANIZATION OF NEURAL ASSEMBLIES

(75) Inventor: Alex Nugent, Santa Fe, NM (US)

(73) Assignee: KnowmTech, LLC

(21) Appl. No.: 12/938,537

(22) Filed: Nov. 3, 2010

Related U.S. Application Data
(60) Provisional application No. 61/285,536, filed on Dec. 10, 2009.

(51) Int. Cl. G06N 3/02

(52) U.S. Cl. 706/21

(57) ABSTRACT

A framework for organization of neural assemblies. Stable neural circuits are formed by generating comprehensions. A packet of neurons projects to a target neuron after stimulation. A target neuron in STDP state is recruited if it fires within a STDP window. Recruitment leads to temporary stabilization of the synapses. The stimulation periods followed by decay periods lead to an exploration of cut-sets. Comprehension results in successful predictions and prediction-mining leads to flow. Flow is defined as the production rate of signaling particles needed to maintain communication between nodes. The comprehension circuit competes for prediction via local inhibition. Flow can be utilized for signal activation and deactivation of post-synaptic and pre-synaptic plasticity. Flow stabilizes the comprehension circuit.

### CROSS-REFERENCE TO PROVISIONAL APPLICATION

This nonprovisional patent application claims the benefit under 35 U.S.C. §119(e) of U.S. Provisional Patent Application Ser. No. 61/285,536 filed on Dec. 10, 2009, entitled “Framework For The Organization of Neural Assemblies,” which is hereby incorporated by reference in its entirety.

### TECHNICAL FIELD

Embodiments are generally related to artificial neural networks. Embodiments also relate to the field of neural assemblies.

### BACKGROUND OF THE INVENTION

The human brain comprises billions of neurons, which are mutually interconnected. These neurons get information from sensory nerves and provide motor feedback to the muscles. Neurons can be stimulated either electrically or chemically. Neurons are living cells which comprise a cell body and different extensions and are delimited by a membrane. Differences in ion concentrations inside and outside the neurons give rise to a voltage across the membrane. The membrane is impermeable to ions, but comprises proteins that can act as ion channels. The ion channels can open and close, enabling ions to flow through the membrane. The opening and closing of the ion channels may be physically controlled by applying a voltage, i.e., via electrical stimulation. The opening and closing of the ion channels may also be chemically controlled by binding a specific molecule to the ion channel.

When a neuron is stimulated, an electrical signal, which may also be called an action potential, is created across the membrane. This signal is transported along the longest extension, called the axon, of the neuron towards another neuron. The two neurons are not physically connected to each other. At the end of the axon, a free space, called the synaptic cleft, separates the membrane of the stimulated neuron from the next neuron. To transfer the information to the next neuron, the first neuron must transform the electrical signal into a chemical signal by the release of specific chemicals called neurotransmitters. These molecules diffuse into the synaptic deft and bind to specific receptors, i.e., proteins, on the second neuron. The binding of a single neurotransmitter molecule can open an ion channel in the membrane of the second neuron and allows thousands of ions to flow through it, rebuilding an electrical signal across the membrane of the second neuron. This electrical signal is then transported again along the axon of the second neuron and stimulates the next one, i.e., a third neuron, and so on.

Neural networks are physical or computational systems that permit computers to function in a manner analogous to that of the human brain. Neural networks do not utilize the traditional digital model of manipulating 0's and 1's. Instead, neural networks create connections between processing elements, which are equivalent to neurons of a human brain. Neural networks are thus based on various electronic circuits that are modeled on human nerve cells (i.e., neurons).

Generally, a neural network is an information-processing network, which is inspired by the manner in which a human brain performs a particular task or function of interest. Computational or artificial neural networks are thus inspired by biological neural systems. The elementary building blocks of biological neural systems are the neuron, the modifiable connections between the neurons, and the topology of the network.

Spike-timing-dependent plasticity (STDP) refers to the sensitivity of synapses to the precise timing of pre and postsynaptic activity. If a synapse is activated a few milliseconds before a postsynaptic action potential (‘pre-post’ spiking), this synapse is typically strengthened and undergoes long-term potentiation (LTP). If a synapse is frequently active shortly after a postsynaptic action potential, it becomes weaker and undergoes long-term depression (LTD). Thus, inputs that actively contribute to the spiking of a cell are ‘rewarded’, while inputs that follow a spike are ‘punished’.

One of the most fundamental features of the brain is its ability to change over time depending on sensation and feedback, i.e., its ability to learn, and it is widely accepted today that learning is a manifestation of the change of the brain's synaptic weights according to certain results. In 1949, Donald Hebb postulated that repeatedly correlated activity between two neurons enhances their connection, leading to what is today called Hebbian cell assemblies, a strongly interconnected set of excitatory neurons. These cell assemblies can be used to model working memory in the form of neural auto-associated memory and thus may provide insight into how the brain stores and processes information.

Many models are used in the field, each defined at a different level of abstraction and trying to model different aspects of neural systems. They range from models of the short-term behavior of individual neurons, through models of how the dynamics of neural circuitry arise from interactions between individual neurons, to models of how behavior can arise from abstract neural modules that represent complete subsystems. These include models of the long-term and short-term plasticity of neural systems and its relation to learning and memory, from the individual neuron to the system level.

It has been known for some time that nerve growth factors (NGF) produced in our brains is needed for a neuron to survive and grow. Neurons survive when only their terminals are treated with NGF indicating that NGF available to axons can generate and retrogradely transport the signaling required for the cell body. NGF must be taken up in the neuron's axon and flow backward toward the neuron's body, stabilizing the pathway exposed to the flow. Without this flow, the neuron's axon will decay and the cell will eventually kill itself.

For units to self-organize into a large assembly, a flow of a substance through the units that gates access to the units energy dissipation should be provided. Money, for example, flows through our economy and gates access to energy. It is a token that is used to unlock local energy reserves and stabilize successful structure. Just as NGF flows backward through a neuron from its axons, money flows backwards through an economy from the products that are sold to the manufacturing systems that produced them. Both gate energy dissipate and are required for survival of a unit within the assembly.

If the organized structure is to persist, the substance that is flowing must itself be an accurate representation of the energy dissipation of the assembly. If it is not, then the assembly will eventually decay as local energy reserves run out. Money and NGF are each tokens or variables that represent energy flow of the larger assembly.

Flow solves the problem of how units within an assembly come to occupy states critical to global function via purely local interactions. If a unit's configuration state is based on volatile memory and this memory is repaired with energy that is gated by flow, then its state will transition if its flow is terminated or reduced. When a new configuration is found that leads to flow, it will be stabilized. The unit does not have to understand the global function. So long as it can maintain flow it knows it is useful. In this way units can organize into assemblies and direct their local adaptations toward higher and higher levels of energy dissipation. Flow resolves the so-called plasticity-stability dilemma. If a node cannot generate flow, then it is not useful to the global network function and can be mutated without consequence. The disclosed embodiments thus relate to a framework for the organization of stable neural assemblies.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an artificial neural assemblies.

It is a further aspect of the present invention to provide for a framework for organization of neural assemblies.

Stable neural circuits are formed by generating comprehensions. A packet of neurons projects to a target neuron in a network after stimulation. The target neuron is recruited if it fires within a STDP window. Recruitment of target neuron leads to temporary stabilization of synapses. The stimulation periods followed by decay periods lead to an exploration of cut-sets. The discovery of comprehension leads to permanent stabilization. The competition between all comprehension circuits leads to continual improvement. Comprehension results in successful predictions, which in turn leads to flow and stabiliity.

Flow is defined as the production rate of signaling particle needed to maintain communication between nodes. The comprehension circuit competes for prediction via local inhibition. Flow can be utilized for signal activation and deactivation of post-synaptic and pre-synaptic plasticity. Flow stabilizes comprehension circuits.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a schematic diagram of a comprehension circuit in a neural assembly, in accordance with the disclosed embodiments;

FIG. 2 illustrates a schematic diagram of a chemical synapse in biological neural network, in accordance with the disclosed embodiments;

FIG. 3 illustrates a schematic diagram of comprehension circuits in a neural assembly with local inhibition, in accordance with the disclosed embodiments;

FIG. 4A illustrates a schematic diagram of a packet of neurons in a network each projecting to a target neuron, in accordance with the disclosed embodiments;

FIG. 4B illustrates a graphical representation firing pattern of a packet of neurons towards a target neuron within a STOP window, in accordance with the disclosed embodiments;

FIG. 5 illustrates a schematic diagram of packet of neurons in a network each projecting to one or more target neurons, in accordance with the disclosed embodiments;

FIG. 6 illustrates a schematic diagram of two overlapping stimuli packets of variable frequency flowed by decay period, in accordance with the disclosed embodiments;

FIG. 7 illustrates a schematic diagram of growing comprehensions in a neural assembly, in accordance with the disclosed embodiments; and

FIG. 8 illustrates a high level flow chart depicting a process of stabilizing neural circuits, in accordance with the disclosed embodiments.

### DETAILED DESCRIPTION

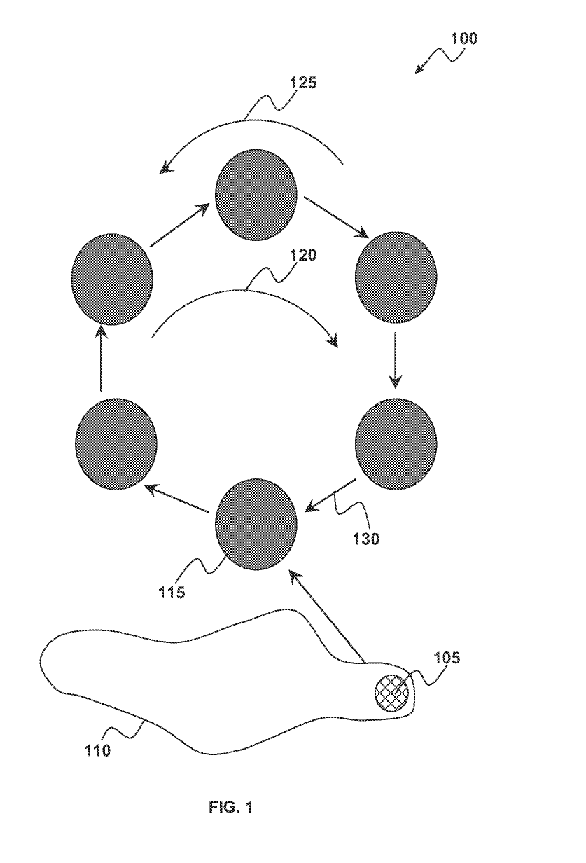

The particular values and configurations discussed in these non-limiting examples can be varied and are cited merely to illustrate at least one embodiment and are not intended to limit the scope thereof. Note that in FIGS. 1-5, identical or similar parts or elements are generally indicated by identical reference numerals.

Artificial neural networks are modes or physical systems based on biological neural networks. They consist of interconnected groups of artificial neurons. Signaling between two nodes in a network requires the production of packets of signaling particles. Signaling particles could be, for example, electrons, atoms, molecules, mechanical vibration, or electrommagnetic vibrations. Neurons and neurotransmitters in biological neural network are analogous to nodes and signaling particles in artificial neural networks respectively.

FIG. 1 illustrates a schematic diagram of a comprehension circuit 100 in a neural assembly, in accordance with the disclosed embodiments. A comprehension 120 is the ability to reliably predict sensory stimulus 105. A node 115 is stimulated to detect an event of an environment 110. The comprehension 120 is equivalent to a scientific theory. It can never be conclusively proven, but only be used to make predictions. The more successful the predictions, more successful the theory. Flow 125 results from the conversion of raw sensory stimulus 105 to the prediction 130 of that stimulus 105. The more successful the prediction 130, greater the flow 125. Flow 125 stabilizes the post-synaptic connections of a neuron. In the absence of flow 125, a node 115 will search the network for flow 125.

Stable neural circuits form through the generation of comprehension 120. Comprehension 120 is the only stable source of flow 125. The stronger the flow 125, the stronger the comprehension 120. The circuit 100 with flow 125 represents a minimal energy state. Overcoming an existing flow circuit with a new flow circuit requires expenditure of energy. The circuit 100 competes for comprehension 120.

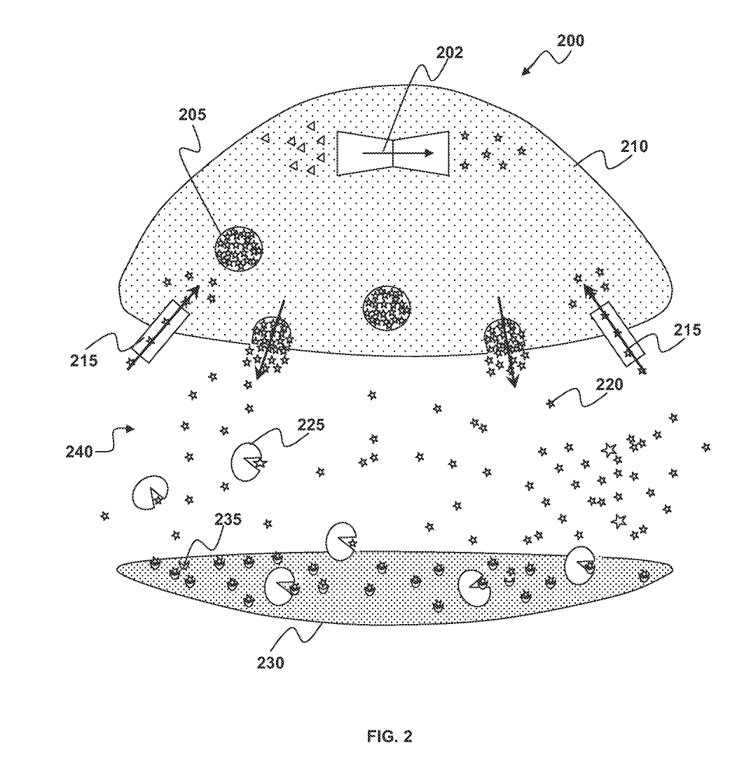

FIG. 2 illustrates a schematic diagram of a chemical synapse 200 in a biological neural network, in accordance with the disclosed embodiments. A synaptic vesicle 205 filled with neurotransmitters 220 are released into a synaptic cleft 240 from a pre-synaptic terminal 210. Flow 202 is the production rate of neurotransmitter 220 needed to insure a constant concentration within the sending neuron. Flow 202 is equal and opposite to the total neurotransmitter 220 lost in enzymatic metabolism. The post-synaptic terminal 230 traps neurotransmitter 220 long enough for enzymes 225 to break it down. Stronger post-synaptic synapses result in higher neurotransmitter 220 metabolism. Re-uptake 215 is thus inversely proportional to the strength of the post-synaptic terminal 230. The number of receptors 235 on the post-synaptic terminal 230 is a function of a post-synaptic plasticity rule.

The plasticity rule extracts computational building blocks from the neural data stream. Flow deactivates postsynaptic plasticity and activates pre-synaptic plasticity. Postsynaptic plasticity is the process of a neuron searching for post-synaptic targets.

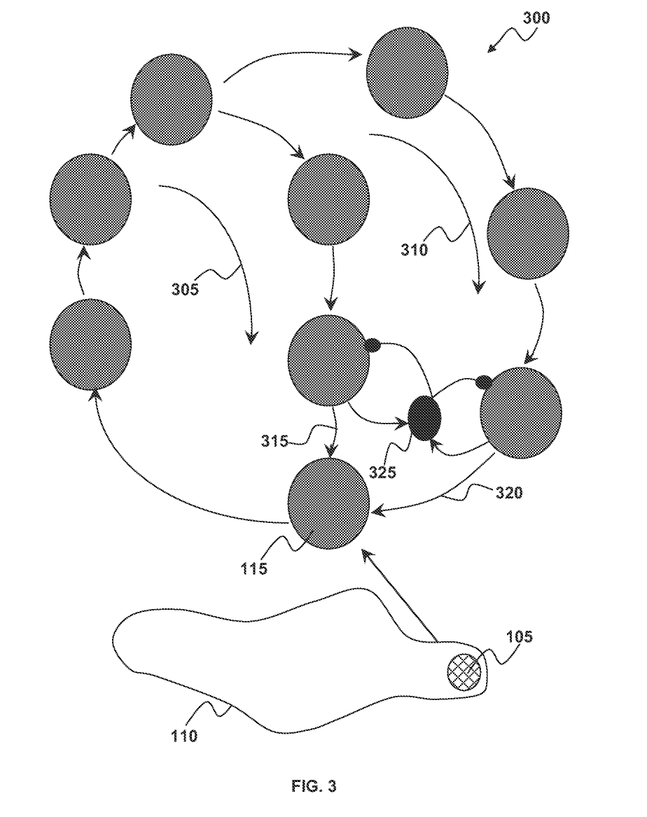

FIG. 3 illustrates a schematic diagram of comprehension circuits 300 of a neural assembly with local inhibition 325, in accordance with the disclosed embodiments. First comprehension circuit 305 and second comprehension circuit 310 compete for predictions 315 and 320 respectively via local inhibition 325. First prediction 315 causes inhibition of competing circuits. No matter the distribution of the comprehension circuits 300, all circuits must converge on the stimulus 105. Thus, local inhibition 325 forces competition of all comprehension circuits 300. Only successful predictions generate flow. Thus, comprehension circuits 300 compete for flow. Unsuccessful predictions search for an alternate flow for stabilization.

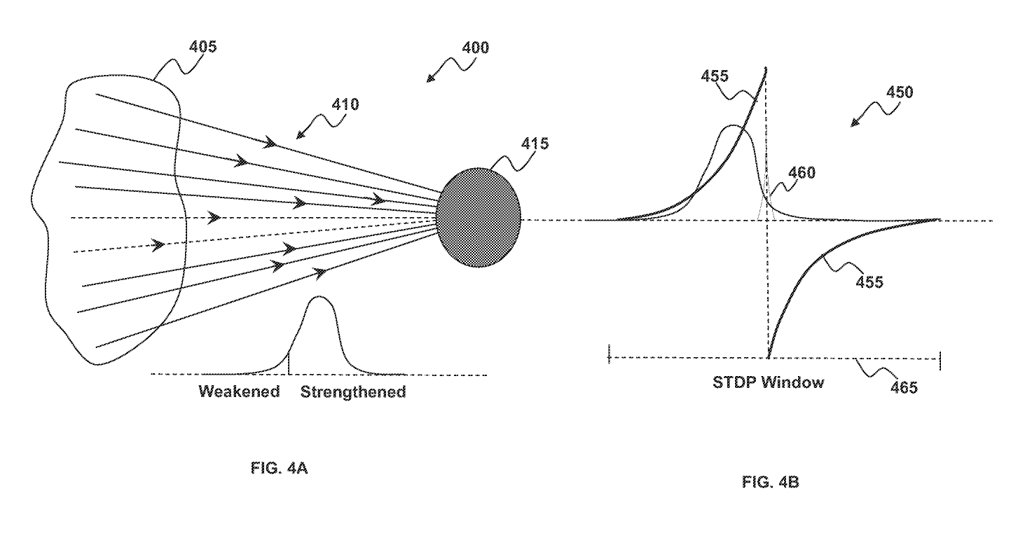

FIG. 4A illustrates a schematic diagram of a spike time dependent plasticity (STOP) 400 showing a packet of neurons 410 in a network 405 each projecting to a target neuron 415, in accordance with the disclosed embodiments. Temporally clustered firing pattern forms the packet of neurons 410. The target neuron 415 is “recruited” if it fires within a STOP window, thus forming a causal chain between the packet of neurons 410 and the target neuron 415. The STOP 400 insures strengthening of the post-synaptic terminal 230. The STOP 400 decreases re-uptake 215 and increases flow of the packet of neurons 410. If the packet of neurons 410 can recruit sufficient targets, its flow will be elevated and the STOP 400 will halt. Thus, the packet of neurons 410 are temporarily stabilized via recruitment without forming a comprehension circuit. In FIG. 4A, weaker and stronger neurons are indicated by dotted and continuous lines, respectively.

FIG. 4B illustrates a graphical representation 450 of firing pattern of the packet of neurons 410 towards the target neuron 415 within a STDP window 465, in accordance with the disclosed embodiments. The graph 460 represents the Firing pattern of weaker neurons and the graphs 455 represents the firing pattern of stronger neurons.

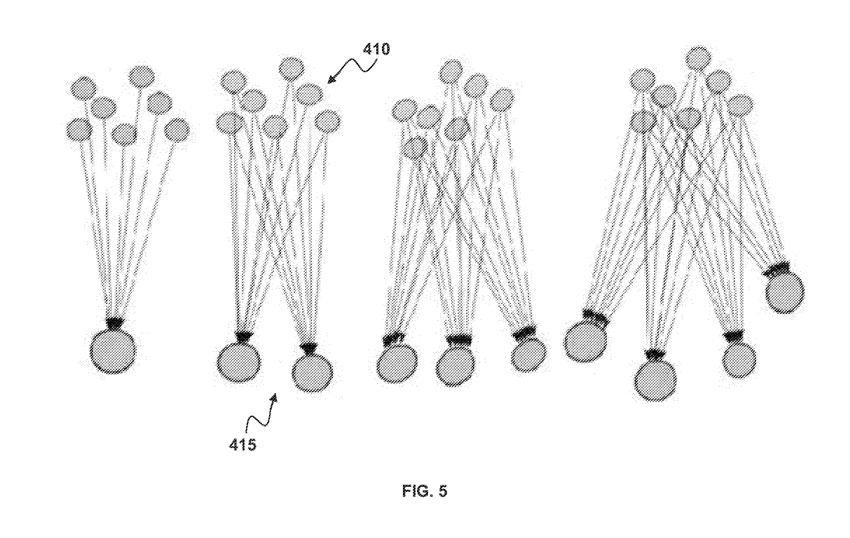

FIG. 5 illustrates a schematic diagram of packet of neurons 410 in the network, each projecting to one or more target neurons 415, in accordance with the disclosed embodiments.

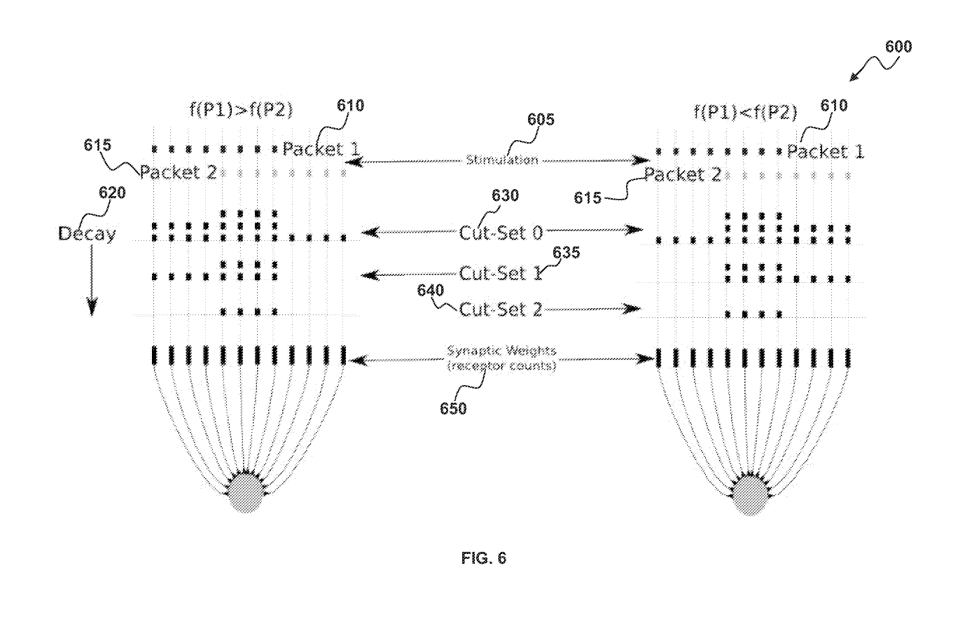

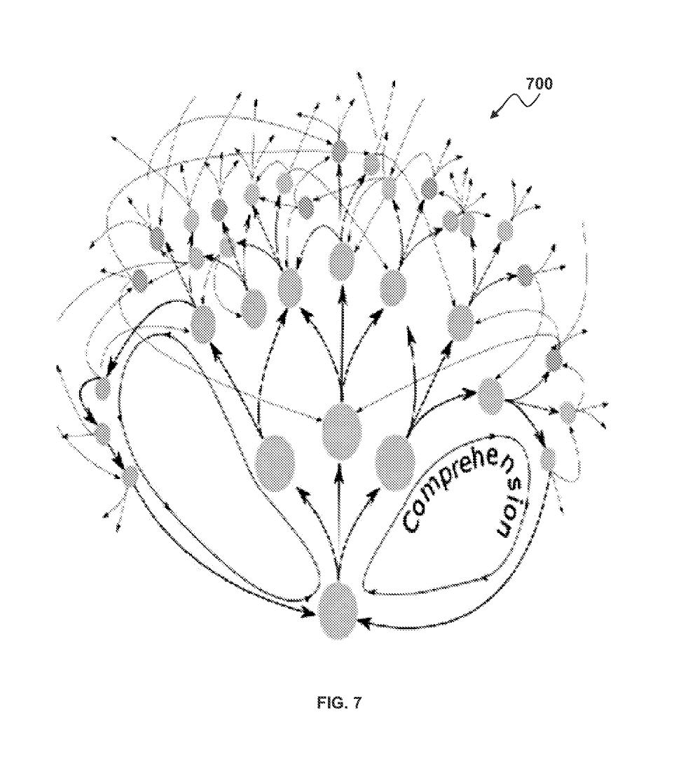

FIG. 6 illustrates a schematic diagram of two overlapping stimuli packets 610 and 615 of variable frequency followed by decay 620, in accordance with the disclosed embodiments. A neuron in the “STDP state” is subject to synaptic decay 620. STDP increases post-synaptic receptor count 650 after stimulation 605. Decay 620 reduces the receptor count 650. Initial cut-set 630 represents selectivity to both packets, the interim cut-set 635 selective to most active packet, and final cut-set 640 selective to overlap of packets. FIG. 7 illustrates a schematic diagram of growing comprehension 700, in accordance with the disclosed embodiments. Stimulation 605 followed by decay 620 leads to an exploration of cut sets 630, 635 and 640.

Recruitment leads to temporary stabilization of the synapses. Cycles of STDP learning followed by decay leads to the exploration of cutsets. The discovery of comprehension leads to permanent stabilization. The competition between comprehension circuits leads to continual improvement. The populations of neurons thus link together in an exploration of cut-sets to find comprehension, stabilized by an “economy of flow”.

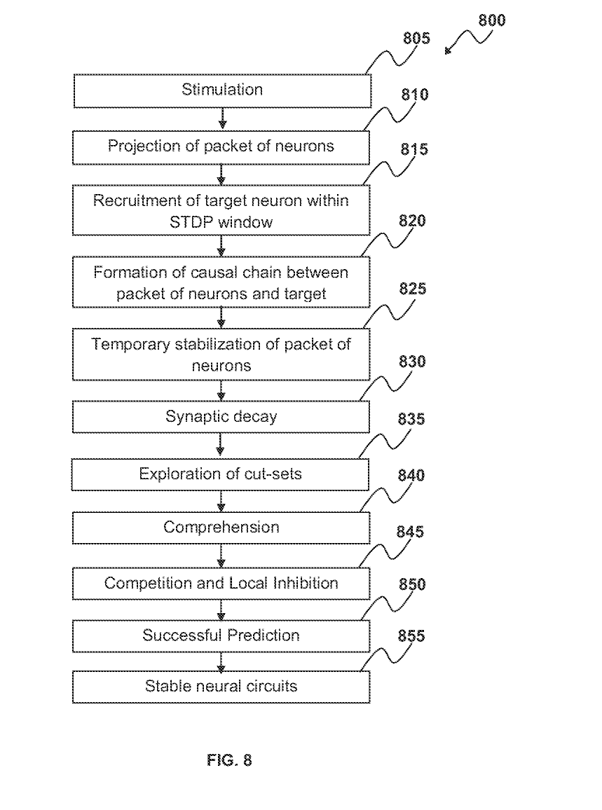

FIG. 8 illustrates a high level flow chart depicting a process 800 of stabilizing neural networks, in accordance with the disclosed embodiment. Initially, the stimulation of signaling particle is initiated, as depicted at block 805. Then, a packet of neurons after stimulation projects to a target neuron, as illustrated at block 810. The target neuron is recruited if it fires within the STDP window and thus forms a causal chain between the packet of neurons and target, as depicted at block 815 and 820 respectively. If the packet of neurons can recruit sufficient targets, its flow will be elevated and STOP will halt. Thus, as illustrated at block 825, packets are temporarily stabilized via recruitment without forming a comprehension circuit.

As depicted at block 830, a neuron in STOP state is subjected to synaptic decay. As illustrated at block 835, stimulation periods followed by decay periods lead to an exploration of cut sets. Stable neural circuits are formed by the generation of comprehension, as illustrated at block 840. The comprehension circuits compete for predictions via local inhibition, as depicted at block 845. As depicted at block 850, only successful predictions generates flow. Finally, flow stabilizes comprehension circuit, as illustrated at block 855.

It will be appreciated that variations of the above disclosed apparatus and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. A method for the organization of neural assemblies, said method comprising:
stimulating a plurality of neurons;
projecting a packet of neurons to at least one target neuron, wherein said target neuron is recruited when fired within a plasticity window to thereby form a causal chain between said packet of neurons and said at least one target neuron;
subjecting a neuron in a state of plasticity to a synaptic decay;
exploring a plurality of cut-sets resulting from a plurality of stimulation periods followed by a plurality of decay periods;
generating a plurality of comprehension circuits;
completing said comprehension circuits for a plurality of predictions via local inhibition;
generating a plurality of flows resulting from said plurality of predictions that are successful; and
stabilizing said plurality of comprehension circuits by said plurality of flows.

2. The method of claim 1 further comprising recruiting a sufficient number of targets by said packet of neurons to result in an elevation of flow and a halt of said post-synaptic plasticity.

3. The method of claim 1 further comprising recruiting a sufficient number of targets by said packet of neurons to result in an elevation of flow and an initiation of said pre-synaptic plasticity.

4. The method of claim 1 further comprising temporarily stabilizing said packet of neurons via recruitment and without forming a comprehension circuit.

5. The method of claim 2 further comprising temporarily stabilizing said packet of neurons via recruitment and without forming a comprehension circuit.

6. The method of claim 3 further comprising temporarily stabilizing said packet of neurons via recruitment and without forming a comprehension circuit.

7. A method for the organization of neural assemblies, said method comprising:
projecting a packet of neurons to at least one target neuron among a plurality of neurons, wherein said target neuron is recruited when fired within a plasticity window to thereby form a causal chain between said packet of neurons and said at least one target neuron;
subjecting a neuron in a state of plasticity to a synaptic decay;
exploring a plurality of cut-sets resulting from a plurality of stimulation periods followed by a plurality of decay periods;
generating a plurality of comprehension circuits;
completing said comprehension circuits for a plurality of predictions via local inhibition;
generating a plurality of flows resulting from said plurality of predictions that are successful; and
stabilizing said plurality of comprehension circuits by said plurality of flows.

8. The method of claim 7 further comprising initially stimulating said plurality of neurons.

9. The method of claim 7 further comprising recruiting a sufficient number of targets by said packet of neurons to result in an elevation of flow and a halt of said post-synaptic plasticity.

10. The method of claim 7 further comprising recruiting a sufficient number of targets by said packet of neurons to result in an elevation of flow and an initiation of said pre-synaptic plasticity.

11. The method of claim 7 further comprising temporarily stabilizing said packet of neurons via recruitment and without forming a comprehension circuit.

12. The method of claim 8 further comprising temporarily stabilizing said packet of neurons via recruitment and without forming a comprehension circuit.

13. The method of claim 9 further comprising temporarily stabilizing said packet of neurons via recruitment and without forming a comprehension circuit.

14. The method of claim 10 further comprising temporarily stabilizing said packet of neurons via recruitment and without forming a comprehension circuit.

15. A system for the organization of neural assemblies, said system comprising:
a plurality of neurons;
a packet of neurons projected to at least one target neuron among said plurality of neurons, wherein said target neuron is recruited when fired within a plasticity window to thereby form a causal chain between said packet of neurons and said at least one target neuron;
a neuron among said plurality of neurons subjected in a state of plasticity to a synaptic decay;
a plurality of cut-sets resulting from a plurality of stimulation periods followed by a plurality of decay periods;
a plurality of comprehension circuits, wherein said plurality of comprehension circuits is completed for a plurality of predictions via local inhibition; and
a plurality of flows resulting from said plurality of predictions that are successful, wherein said plurality of comprehension circuits is stabilized by said plurality of flows.

16. The system of claim 15 further comprising a sufficient number of targets recruited by said packet of neurons to result in an elevation of flow and a halt of said post-synaptic plasticity.

17. The system of claim 15 further comprising a sufficient number of targets recruited by said packet of neurons to result in an elevation of flow and an initiation of said pre-synaptic plasticity.

18. The system of claim 15 wherein said packet of neurons is stabilized via recruitment and without forming a comprehension circuit.

19. The system of claim 16 wherein said packet of neurons is stabilized via recruitment and without forming a comprehension circuit.

20. The system of claim 17 wherein said packet of neurons is stabilized via recruitment and without forming a comprehension circuit.
